(19) United States
(12) Patent Application Publication
(10) Pub. No.: US 2026/0011260 A1
(43) Pub. Date: Jan. 8, 2026

(54) INFORMATION PROCESSING APPARATUS, INFORMATION PROCESSING METHOD, AND NON-TRANSITORY COMPUTER-READABLE MEDIUM

(71) Applicant: NEC Corporation, Tokyo (JP)

(72) Inventors: Kazushi MIYAGI, Tokyo (JP); Shinnosuke NISHIMOTO, Tokyo (JP); Seiichi YAMAMOTO, Tokyo (JP)

(73) Assignee: NEC Corporation, Tokyo (JP)

(21) Appl. No.: 19/238,813

(22) Filed: Jun. 16, 2025

(30) Foreign Application Priority Data
Jul. 2, 2024 (JP) 2024-106656

(51) Int. Cl. G09B 7/02; G06Q 10/0631; G06Q 50/20

(52) U.S. Cl. CPC G09B 7/02; G06Q 10/06314; G06Q 50/2057

(57) ABSTRACT

The purpose of the present invention is to support the utilization of training in business. An information processing apparatus is provided which includes an acquisition unit that acquires input information regarding a review of training from an employee, an extraction unit that extracts a learning content of the employee in the training based on the input information, and an output unit that outputs coaching card information based on information extracted by the extraction unit.

### INCORPORATION BY REFERENCE

This application is based upon and claims the benefit of priority from Japanese patent application No. 2024-106656, filed on Jul. 2, 2024, the disclosure of which is incorporated herein in its entirety by reference.

### TECHNICAL FIELD

The present disclosure relates to an information processing apparatus, an information processing method, and a program.

### BACKGROUND ART

Patent Literature 1 discloses a technique for maintaining motivation of a user. In Patent Literature 1, target information including a target to be executed by a user is set based on initial setting information including information regarding the user, and a comment with respect to an answer of the user to the target information is generated.
Patent Literature 1: Japanese Unexamined Patent Application Publication No. 2023-136508

### SUMMARY

For example, Patent Literature 1 does not consider utilizing training for employees for human resources development in a company for actual work.

An example object of the present disclosure is to provide a technique that can support utilizing training in business in view of the above-described problems.

According to a first example aspect of the present disclosure, there is provided an information processing apparatus including: an acquisition unit that acquires input information regarding a review of training from an employee; an extraction unit that extracts a learning content of the employee based on the input information; and an output unit that outputs coaching card information based on information extracted by the extraction unit.

According to a second example aspect of the present disclosure, there is provided an information processing method including: acquiring input information regarding a review of training from an employee; extracting a learning content of the employee based on the input information; and outputting coaching card information based on the extracted information.

According to a third example aspect of the present disclosure, there is provided a program for causing a computer to execute: acquiring input information regarding a review of training from an employee; extracting a learning content of the employee based on the input information; and outputting coaching card information based on the extracted information.

According to one aspect, for example, it is possible to support utilizing the training in business.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram illustrating an example of a configuration of an information processing apparatus according to an example embodiment;

FIG. 2 is a diagram illustrating a configuration example of an information processing system according to an example embodiment;

FIG. 3 is a diagram illustrating a hardware configuration example of the information processing apparatus according to the example embodiment;

FIG. 4 is a flowchart illustrating an example of processing of the information processing apparatus according to the example embodiment;

FIG. 5 is a diagram illustrating an example of coaching card information according to an example embodiment;

FIG. 6 is a diagram illustrating an example of information stored in an employee database (DB) according to the example embodiment;

FIG. 7 is a diagram illustrating an example of a chat display screen 701 in a case of interactively extracting a learning content or the like according to the example embodiment; and

FIG. 8 is a diagram illustrating an example of a chat display screen 801 in a case of interactively performing coaching assistance according to the example embodiment.

### EXAMPLE EMBODIMENT

The principles of the present disclosure will be described with reference to several example embodiments. It is to be understood that the example embodiments have been described for purposes of illustration only and will aid those skilled in the art in understanding and carrying out the present disclosure without suggesting limitations on the scope of the present disclosure. The disclosure described in the present specification is implemented in various methods other than those described below.

In the following description and claims, unless defined otherwise, all technical and scientific terms used in the present specification have the same meaning as commonly understood by those skilled in the art of the technical field to which the present disclosure belongs.

Hereinafter, example embodiments of the present disclosure will be described with reference to the drawings. Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

### First Example Embodiment

### <Configuration>

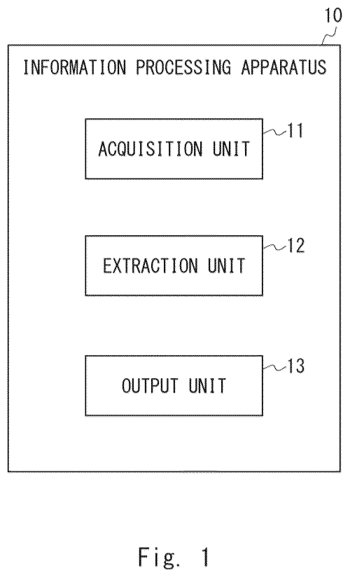

A configuration of an information processing apparatus 10 according to an example embodiment will be described with reference to FIG. 1. FIG. 1 is a diagram illustrating an example of the configuration of the information processing apparatus 10 according to the example embodiment. The information processing apparatus 10 includes an acquisition unit 11, an extraction unit 12, and an output unit 13. These units may be implemented by cooperation of one or more programs installed in the information processing apparatus 10 and hardware such as a processor and a memory of the information processing apparatus 10.

The acquisition unit 11 acquires input information regarding a review of the training from the employee. The extraction unit 12 extracts learning contents and the like of the employee based on the input information acquired by the acquisition unit 11. The output unit 13 outputs the coaching card information based on the learning content extracted by the extraction unit 12.

### Second Example Embodiment

### <System Configuration>

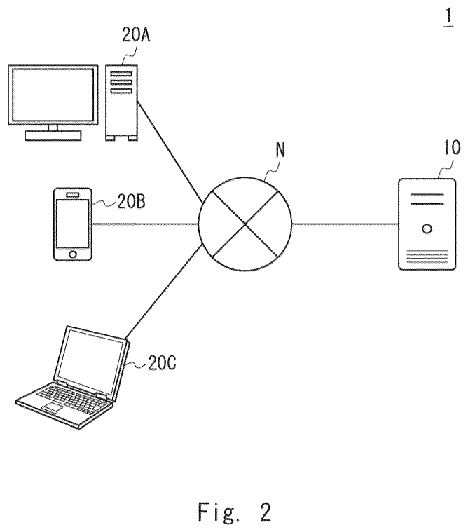

Next, a configuration of an information processing system 1 according to an example embodiment will be described with reference to FIG. 2. FIG. 2 is a diagram illustrating a configuration example of the information processing system 1 according to the example embodiment. In the example of FIG. 2, the information processing system 1 includes the information processing apparatus 10 and employee terminals 20A to 20C. Hereinafter, each of the employee terminals 20A to 20C will be simply referred to as an “employee terminal 20” in a case where it is not necessary to distinguish between them.

In the example of FIG. 2, the information processing apparatus 10 and the employee terminal 20 are connected so as to be able to communicate with each other via a network N. The number of information processing apparatuses 10 and the number of the employee terminals 20 are not limited to those in the example of FIG. 2.

Examples of the network N include the Internet, a mobile communication system, a wireless local area network (LAN), a LAN, and a bus. Examples of the mobile communication system include a fifth generation mobile communication system (5G), a sixth generation mobile communication system (6G and Beyond 5G), a fourth generation mobile communication system (4G), and a third generation mobile communication system (3G).

The information processing apparatus 10 is, for example, an apparatus such as a server, a cloud server, a personal computer, or a smartphone. For example, the information processing apparatus 10 generates coaching card information including learning contents of an employee in training based on input information regarding a review of the training from the employee.

The employee terminal 20 is, for example, a terminal used by an employee in business activities, such as a personal computer (PC), a smartphone, a tablet, or a wearable device.

### <Hardware Configuration>

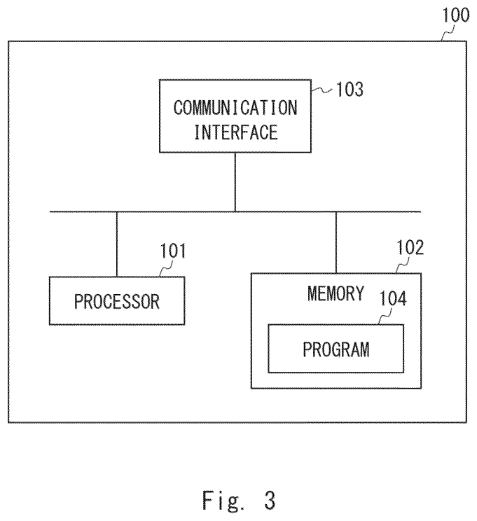

FIG. 3 is a diagram illustrating a hardware configuration example of the information processing apparatus 10 according to the example embodiment. In the example of FIG. 3, the information processing apparatus 10 (computer 100) includes a processor 101, a memory 102, and a communication interface 103. These units may be connected by a bus or the like. The memory 102 stores at least a part of a program 104. The communication interface 103 includes an interface necessary for communication with other network elements.

In a case where the program 104 is executed by the cooperation of the processor 101, the memory 102, and the like, at least a part of processing according to the example embodiment of the present disclosure is performed by the computer 100. The memory 102 may be of any type. The memory 102 may be a non-transitory computer-readable storage medium, as a non-limiting example. The memory 102 may also be implemented using any suitable data storage technique such as a semiconductor-based memory device, a magnetic memory device and system, an optical memory device and system, a fixed memory, or a removable memory. Although only one memory 102 is illustrated in the computer 100, there may be several physically different memory modules in the computer 100. The processor 101 may be of any type. The processor 101 may include one or more of a general purpose computer, a dedicated computer, a microprocessor, a digital signal processor (DSP), and a processor based on a multi-core processor architecture as a non-limiting example. The computer 100 may include a plurality of processors such as application specific integrated circuit chips that are temporally dependent on a clock that synchronizes the main processor.

The example embodiments of the present disclosure may be implemented in hardware or dedicated circuitry, software, logic, or any combination thereof. Some aspects may be implemented in hardware, while other aspects may be implemented in firmware or software that may be executed by a controller, a microprocessor or other computing devices.

The present disclosure also provides at least one computer program product tangibly stored on a non-transitory computer-readable storage medium. The computer program product includes computer-executable instructions, such as those included in a program module, and is executed on a device on a target real or virtual processor to perform the processes or methods of the present disclosure. The program module includes routines, programs, libraries, objects, classes, components, data structures, and the like that execute particular tasks or implement particular abstract data types. Functions of the program module may be combined or divided between the program modules as desired in various example embodiments. A machine-executable instruction of the program module can be executed in a local or distributed device. In the distributed device, the program modules can be located on both local and remote storage media.

Program codes for executing the methods of the present disclosure may be written in any combination of one or more programming languages. These program codes are provided to a processor or controller of a general purpose computer, a dedicated computer, or other programmable data processing apparatuses. In a case where the program code is executed by the processor or controller, the functions/operations in the flowcharts and/or the implemented block diagrams are performed. The program code is executed entirely on a machine, partially on the machine as a stand-alone software package, partially on the machine and partially on a remote machine, or entirely on the remote machine or server.

The program can be stored and supplied to the computer using various types of non-transitory computer-readable media. The non-transitory computer-readable medium includes various types of tangible recording media. Examples of the non-transitory computer-readable medium include a magnetic recording medium, a magneto-optical recording medium, an optical disc medium, and a semiconductor memory. Examples of the magnetic recording medium include a flexible disk, a magnetic tape, and a hard disk drive. Examples of the magneto-optical recording medium include a magneto-optical disk. Examples of the optical disc medium include a Blu-ray disc, a compact disc (CD)-read only memory (ROM), a CD-recordable (R), and a CD-rewritable (RW). Examples of the semiconductor memory include a solid state drive, a mask ROM, a programmable ROM (PROM), an erasable PROM (EPROM), a flash ROM, and a random access memory (RAM). The program may be supplied to the computer using various types of transitory computer-readable media. Examples of the transitory computer-readable media include electrical signals, optical signals, and electromagnetic waves. The transitory computer-readable media can supply the programs to the computer via a wired communication path such as an electric wire and an optical fiber or a wireless communication path.

### <Processing>

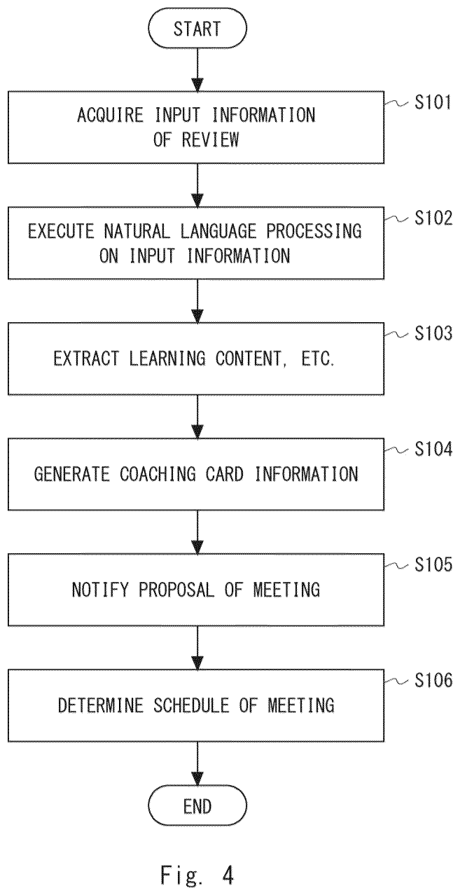

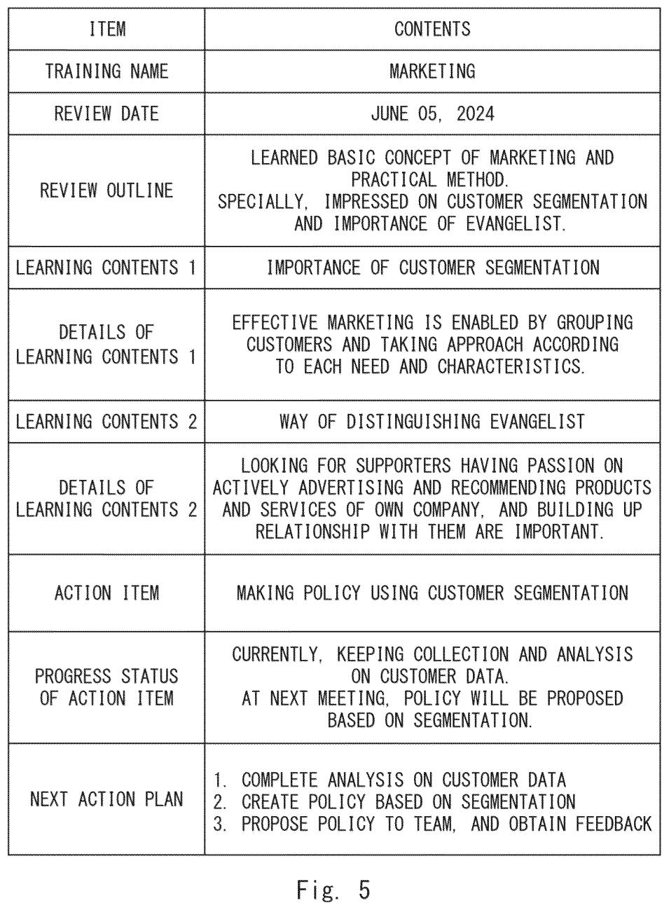

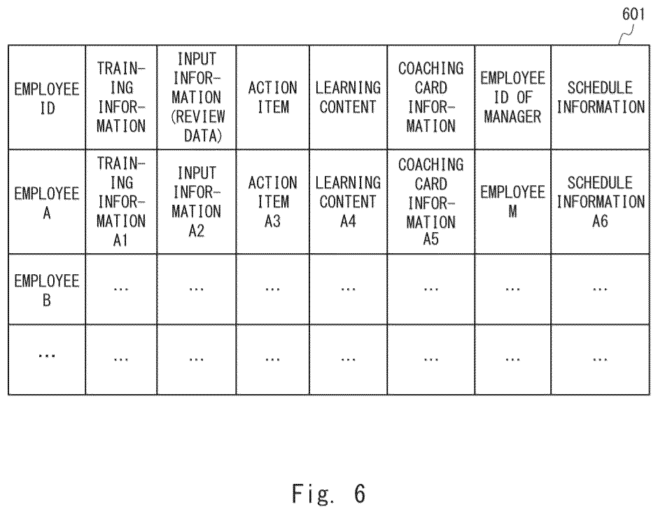

Next, an example of processing of the information processing apparatus 10 according to the example embodiment will be described with reference to FIGS. 4 to 6. FIG. 4 is a flowchart illustrating an example of the processing of the information processing apparatus 10 according to the example embodiment. FIG. 5 is a diagram illustrating an example of coaching card information according to the example embodiment. FIG. 6 is a diagram illustrating an example of information stored in an employee database (DB) 601 according to the example embodiment.

In step S101, the acquisition unit 11 acquires input information regarding a review of the training from the employee. Here, for example, the acquisition unit 11 may review a specific training (meeting) and acquire, as input information, information (“review”) such as what has been learned in the training, how to utilize the content learned in the training for actual work, and matters to be further learned based on the training. For example, the acquisition unit 11 may acquire the review from text data input by the employee through the chat interface.

The acquisition unit 11 may automatically detect the end of training in cooperation with, for example, a training schedule and an attendance management system. Then, in a case where the acquisition unit 11 detects the end of the training, the acquisition unit may transmit an automatic message to the employee to input a review.

For example, the acquisition unit 11 may transmit, to the employee terminal 20, a message such as “Mr. A, you worked hard in training today. Please review the training contents and input what you have learned and are aware of. By entering reviews, the effect of training can be further enhanced.” to prompt for a review.

Subsequently, the extraction unit 12 executes natural language processing on the input information acquired by the acquisition unit 11 (step S102). Here, the extraction unit 12 may perform, for example, morphological analysis, syntax analysis, semantic analysis, and the like on the input information.

Subsequently, the extraction unit 12 extracts an action item, learning contents, and the like of the employee based on the natural language processing result of the input information (step S103). Here, the extraction unit 12 may extract the action item and the learning content from the review using a method such as rule-based pattern matching or classification by a machine learning model. Here, the action item may be, for example, a future action or implementation item mentioned in the review. The learning content may be an awareness, a lesson, or the like obtained from the review.

The action item may be referred to by various names depending on an organization and a use situation. The action item may be referred to as a task, an action plan, a next step, an execution item, a To-Do item, an improvement point, a commitment item, or the like.

For example, a review such as “In today's meeting, we had active discussions on the new proposal. In particular, it was possible to learn a method of visualizing an idea. Make a draft plan by the next time and consult the manager.” is input. For example, the extraction unit 12 may extract a portion of “Make a draft plan by the next time and consult the manager” as an action item. The extraction unit 12 may extract, for example, a portion “it was possible to learn a method of visualizing an idea” as the learning content. For example, the extraction unit 12 may convert the extracted information into data in a structured format (for example, JSON (JavaScript Object Notation) format).

The extraction unit 12 may extract information indicating a training name, a review date, a review outline, learning contents, details of the learning contents, an action item, a progress status of the action item, and a next action plan based on the natural language processing result of the input information.

Subsequently, the output unit 13 generates coaching card information based on the learning content or the like extracted by the extraction unit 12 (step S104). The output unit 13 may output the coaching card information in a format such as a hypertext markup language (HTML) or a portable document format (PDF). The coaching card information is a document summarizing main points of the review, and may be data that promotes employee's awareness and behavior change.

The coaching card information may include information such as a date and outline of the review, learning contents including awareness, precepts, and the like obtained in the review, related action items, a progress status of the action items, a next action plan, a goal, and the like. The employee can check his/her growth and progress by referring to the coaching card information. The manager can have an appropriate interview with the employee by referring to the coaching card information. The coaching card information may be referred to as various names depending on an organization and a use situation. The coaching card information may be referred to as a review sheet, a training record, an Individual Development Plan (IDP), a learning diary, a skill development sheet, a carrier progress card, a performance tracker, a growth record note, or the like.

FIG. 5 illustrates an example of the coaching card information according to the example embodiment. In the example of FIG. 5, the content of the coaching card information is expressed by two columns of an item and a content. The item column includes a training name, a review date, a review outline, learning contents, details of the learning contents, an action item, a progress status of the action item, a next action plan, and the like. Specific information relevant to each item is filled in the content column. With this table format, the content of the coaching card information can be structured and organized for easy viewing.

The output unit 13 may record coaching card information or the like in the employee DB 601. In the example of FIG. 6, input information (review data), one or more action items, one or more learning contents, and coaching card information are recorded in the employee DB 601 in association with a combination of an employee ID and training information. The employee ID of the manager and the schedule information are recorded in association with the employee ID. The training information is training information to be reviewed by the employee. The training information may include, for example, information such as a training ID, a training name, and a training period, which are identification information of training. The employee ID of the manager is an employee ID of a manager (for example, the supervisor) of the employee. The employee ID of the manager may be set in advance by, for example, an operator of the information processing apparatus 10 or the like.

The information recorded in the employee DB 601 may be utilized for various analyses such as visualization of a review tendency (frequency, content tendency, etc.) for each employee, tracking and management of a progress status of an action item, classification of learning contents and creation of a skill map, and analysis of a utilization status of coaching card information and an influence on behavior change. For these analyses, a method of machine learning or data mining may be used. For example, the information processing apparatus 10 may analyze the content of the coaching card information using natural language processing to find an effective review pattern. The result of the analysis may be visualized in the form of a dashboard or a report, and may be used for planning of measures for human resources development and support of individual employees.

Subsequently, in a case where a specific action item is extracted by the extraction unit 12, the output unit 13 transmits a meeting proposal (meeting holding notification) to the employee and the manager (step S105). The notification may include the purpose of the meeting (consultation regarding execution of the action item), related review content, and coaching card information. In the above-described review example, the output unit 13 may determine that a meeting between the employee and the manager is necessary based on a specific action item “I want to consult the manager”.

Subsequently, the output unit 13 sets a schedule of a meeting in cooperation with a schedule management system, and in a case where approval for participation is obtained by each participant, the output unit determines a schedule of the meeting and registers the schedule in the calendar of the schedule of each participant (step S106). Here, for example, the output unit 13 may cooperate with a cloud service for schedule management, search for free time of participants, and propose an optimal date and time.

The employee and the manager can hold an interview using coaching card information or the like. This improves the quality and efficiency of the interview and has beneficial effects for both employees and managers. That is, it is possible to improve the quality of communication between people and to easily change the behavior of the employee.

### Example of Use Case

Hereinafter, an example of a use case in a case where an employee participates in “marketing” training will be described. After training, the employee may input a review from the chat interface. For example, the employee inputs “I have taken marketing training and have a better understanding of the importance of customer segmentation. In particular, the way of distinguishing the evangelist was impressive. I would like to utilize customer segmentation in planning future measures”.

The extraction unit 12 may apply morphological analysis, syntax analysis, semantic analysis, and the like to the input text data. As a result, the structure and semantic contents of the sentence are understood and converted into a form that can be mechanically processed. For example, the extraction unit 12 extracts keywords such as “customer segmentation” and “evangelist”, and analyzes a relationship therebetween.

Then, the extraction unit 12 may extract the action item and the learning content from the review content based on the analysis result. In this example, “I would like to utilize customer segmentation in planning future measures” is extracted as an action item, and “importance of customer segmentation” and “the way of distinguishing the evangelist” are extracted as learning contents. The extraction result is stored as structured data in a JSON format or the like.

The output unit 13 may propose a meeting between the employee and the manager with the extraction of the action item as a trigger. The purpose of the meeting may be consultation for planning measures utilizing customer segmentation. The notification of the meeting proposal may include a review content related to the action item.

The output unit 13 may confirm schedules of the employee and the manager, search free time of both, and propose an optimal date and time. For example, it may be proposed that “10:00 to 11:00 on next Monday are free time of both sides”. In response to both sides approving the proposed date and time, the schedule of the meeting is confirmed and registered in each calendar.

The output unit 13 may generate coaching card information in which the review content and the extracted learning content are collected. The coaching card information may include a training name “marketing”, a date and outline of review, details of learning contents “importance of customer segmentation” and “the way of distinguishing the evangelist”, a related action item “planning of measures utilizing customer segmentation” and its progress status, a next action plan, and the like. The output unit 13 may output the generated coaching card information in a PDF format, for example, and distribute the information to the employee or the manager.

The output unit 13 may accumulate (record) review data, action items, learning contents, coaching card information, and the like generated in a series of activities. The accumulated data may be utilized for various analyses. For example, it may be used to analyze the review contents of the entire participants of the marketing training and grasp the tendency of a topic with a high comprehension level or a frequently extracted action item. The training effect may be evaluated by analyzing the utilization status of the coaching card information and the influence on the subsequent planning of measures. In this manner, by supporting a series of processes from participation in training to review, execution of an action plan, and follow-up by utilizing natural language processing and machine learning techniques, maximization of training effects and action change of employees can be promoted.

### Example of Generating Interactive Response

Input information of training review from employees may be obtained using interactive response generation. The extraction unit 12 may use, for example, a language model. For example, the extraction unit 12 may generate an interactive response to the input review text data by using a pre-learned language model. This enables, for example, interactive and flexible review support. It is possible to achieve detailed support close to each employee's review.

Here, a language model according to the example embodiment will be described. The language model is a machine learning model (also referred to as a generation model) that inputs a language and outputs a language. The language model is a model that learns a relationship between words in a sentence and generates a relevant character string related to a target character string from the target character string. By using a language model in which sentences and paragraphs in various contexts are learned, it is possible to generate a relevant character string having appropriate contents related to the target character string. In response to a prompt (query) including an instruction related to a response or the like being input, the language model outputs an answer relevant to the prompt.

A learning method of the language model is not particularly limited, but as an example, the language model may be learned so as to output at least one sentence including an input character string. As a specific example, the language model may be a GPT (Generative Pretrained-Transformer) that outputs a sentence including an input character string by predicting a character string having a high probability following the input character string. The language model may be text-to-text transfer transformer (T5), bidirectional encoder representations from transformers (BERT), robustly optimized BERT approach (ROBERTa), or efficiently learning an encoder that classifies token replacements accurately (ELECTRA).

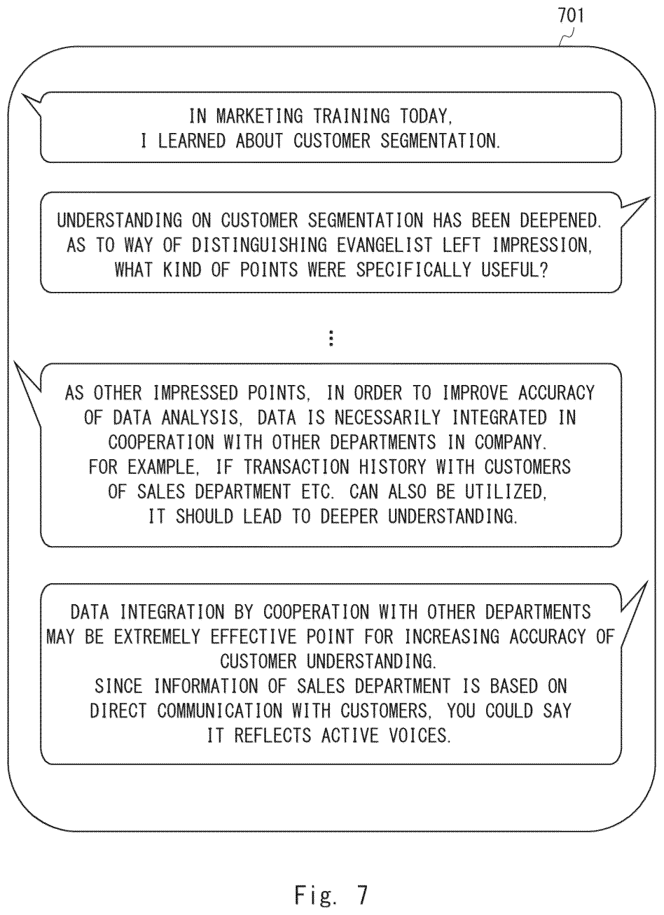

The extraction unit 12 may ask the employee an additional question about an action item or learning content to be extracted from the text data of the review. In response to the extraction unit 12 obtaining a response from the employee, the extraction unit may interactively advance the extraction of the action item and the learning content as illustrated in FIG. 7 by asking a more detailed question based on the information.

FIG. 7 is a diagram illustrating an example of a chat display screen 701 in a case of interactively extracting a learning content or the like according to the example embodiment. In response to the employee inputting his/her learning or awareness acquired in the training as text data, the extraction unit 12 may analyze the content of the text data and estimate the employee's comprehension level and matters of interest. Then, the extraction unit 12 may ask a specific question in order to further deepen the employee's review. In the example of FIG. 7, the question by the extraction unit 12 “As to the way of distinguishing the evangelist left an impression, what kind of points were specifically useful?” is intended to draw out a hint for the employee to assimilate the training contents by himself/herself and utilize the contents for practice. In response to the employee answering the question, the extraction unit 12 may analyze the answer and perform a more detailed question. By repeating this, the extraction unit 12 may interactively deepen the employee's review.

The extraction unit 12 may automatically extract an action item (matter to be transferred to an actual action) and a learning content (obtained knowledge and skill) from a statement content (text data) of an employee in a chat. As a result, the employee can organize his/her review and clarify a specific next measure.

The extraction unit 12 may also refer to new awareness and tasks derived from employee's review. In the above example, by referring to “data cooperation with other departments” and “enhancement of customer orientation in the entire organization”, it is urged to broaden the field of vision of employees and to review from a broader viewpoint.

As described above, through the interactive interaction between the extraction unit 12 and the employee, interactive and deep review is achieved instead of mere one-way review. The extraction unit 12 appropriately interprets the speech of the employee and makes questions and proposals according to the context, so that it is possible to effectively draw out awareness of the employee and support continuous growth.

The extraction unit 12 may generate a flexible response according to the context while referring to information such as past review data and related documents. As a result, it is possible to cope with various review patterns that are relatively difficult to cope with by the rule-based fixed processing.

The language model used in the extraction unit 12 can be further subjected to advanced processing by performing fine tuning specialized for the review support task. Specifically, the extraction unit 12 can enhance the extraction accuracy of the action item and the learning content by additionally learning past excellent review cases as training data. For example, the extraction unit 12 may use a model machine-learned using a combination of past input information and learning contents as training data.

### Example of Supporting Manager

The information processing apparatus 10 may support the manager to further enhance the coaching to the employee in a case where the manager grasps the review content of the employee and performs a more effective meeting. Using the coaching card information, the output unit 13 may respond to a question from the manager using a natural language processing technology. The output unit 13 may be achieved using, for example, a large-scale language model. By fine-tuning the large-scale language model specifically for a coaching dialogue task, it is possible to generate a more natural and contextually appropriate response. It is also possible to continuously improve the model by the manager feeding back the insight obtained from the interaction to the model. For example, in a case where the manager evaluates that “this question example is better to be more specific”, the manager may cause the model to perform additional learning using the evaluation as learning data. As a result, know-how of coaching unique to the organization can be reflected in the model.

The output unit 13 may generate coaching option information in addition to the coaching card information. The coaching option information is information indicating a plurality of coaching directionalities and specific advice as options based on the learning content of the employee and the extracted action item.

For example, in a case where the extracted learning content is “importance of customer segmentation”, the output unit 13 may generate the following coaching options.
(1) Specifically consider how customer segmentation can be utilized in actual operations.
(2) Enhance data cooperation with other departments and promote collection and analysis of customer data.
(3) Prepare measures to enhance customer orientation throughout the entire organization.

The manager can conduct a meeting with the employee while referring to such coaching options. Each option may be accompanied by more detailed description or advice. In this way, by preparing the coaching option information, the manager can efficiently select the optimal coaching directionality according to the employee, and more detailed coaching can be performed. By repeating the discussion based on the options, it is easy to make a specific action plan together with the employee.

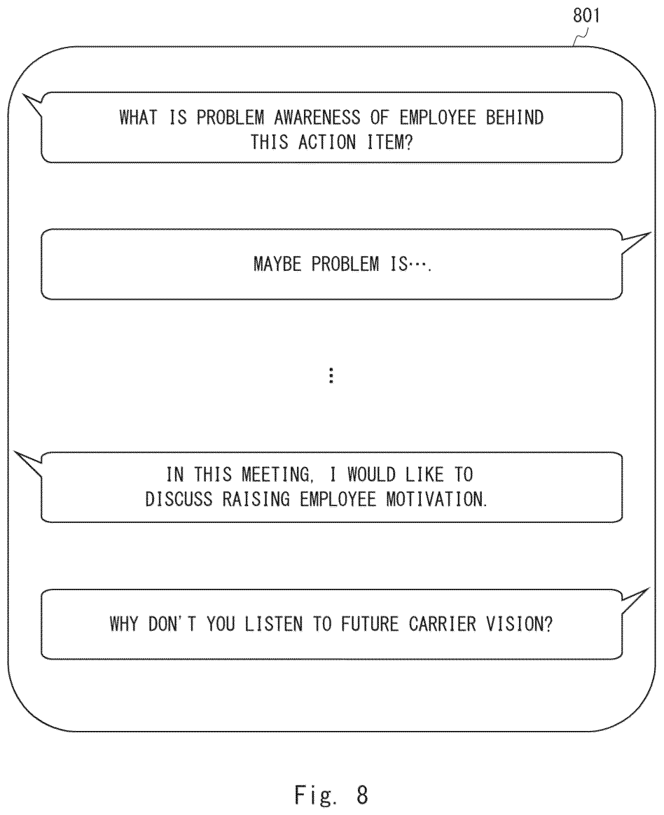

The output unit 13 may answer a question from the manager as illustrated in FIG. 8. FIG. 8 is a diagram illustrating an example of a chat display screen 801 for interactively providing coaching assistance according to the example embodiment. In the example of FIG. 8, a question “What is the problem awareness of the employee behind this action item?” is input from the manager. The output unit 13 may analyze the content of the coaching card information, the past review data, and the like, and generate an appropriate answer after understanding the intention of the question.

The output unit 13 may provide a hint of a question that the manager should ask the employee at the meeting. For example, it is assumed that the manager inputs a request such as “In this meeting, I would like to discuss raising employee motivation”. The output unit 13 may analyze the content of the coaching card information and output (present) an example of a question such as “What is the barrier to implementing the contents learned in the training?” or “Why don't you listen to the future carrier vision?”.

As a result, for example, the manager can face the meeting after understanding the situation of the employee more deeply. It is possible to improve the quality of the meeting by not only simply reading the coaching card information but also solving a question about the coaching card information and grasping a point to be dug down.

### <Others>

It is not easy to utilize the contents of the training in actual work and lead to behavior change. Conventionally, employee reviews are often performed according to a standardized template, and tend to lack flexibility. A mechanism for utilizing the contents of review for business improvement is not sufficient.

On the other hand, according to the present disclosure, coaching card information including information such as learning contents is generated based on input information regarding review of training from an employee. As a result, for example, it is possible to support utilizing the training in business.

### Modified Example

The output unit 13 may analyze the interview result and give feedback. The output unit 13 may generate information useful for at least one of the employee and the manager by performing information processing on the interview result. For example, the output unit 13 may generate more effective feedback by performing transcription from the speech of the interview and summarizing and analyzing the speech using the language model. The output unit 13 may understand the content of the interview using the language model, extract important points, and generate a summary. Furthermore, the output unit 13 may propose advice or improvement points to the manager or the employee while considering the context of the interview. For example, advice such as “it is necessary to improve communication skills” or “specific target setting is effective” may be notified to the employee or the manager.

The output unit 13 may perform emotion analysis from the voice data to estimate the emotion state of the interview participant. For example, the output unit 13 may extract prosody characteristics (pitch, volume, speed, etc.) of the speech of the interview participant and classify the emotion using a machine learning model (for example, a support vector machine or a convolutional neural network).

Alternatively, the output unit 13 may also analyze biological information (heart rate, electrodermal activity, body temperature, etc.) acquired using a wearable device to estimate stress and emotions with higher accuracy. For example, a decrease in heart rate variability (HRV) or an increase in electrodermal activity (EDA) can be used as an index indicating a stress state.

The output unit 13 may analyze these data in time series to visualize at which point in the interview the participant's emotions and stress levels have changed. Specifically, a graph for measuring the time on the horizontal axis and the emotion intensity and the stress level on the vertical axis may be generated, and the topic and the important event of the interview content may be superimposed and displayed thereon. As a result, the output unit 13 can visually grasp the reaction of the participant to a specific topic or question. For example, the output unit 13 can generate a specific insight such as “the stress level increased at the time after the topic of the performance evaluation enters”. By the output unit 13 providing such emotion analysis and integrated analysis of vital data, it is possible to qualitatively evaluate the interview, and more effective communication and human resources development can be achieved.

### Second Modified Example

The information processing apparatus 10 may be an apparatus contained in one housing, but the information processing apparatus 10 of the present disclosure is not limited thereto. Each unit of the information processing apparatus 10 may be implemented by, for example, cloud computing including one or more computers. The information processing apparatus 10 and the employee terminal 20 may be housed in the same housing and configured as an integrated information processing apparatus. At least a part of the processing of each functional unit of the information processing apparatus 10 may be executed by the employee terminal 20. Such an information processing apparatus 10 is also included in an example of the “information processing apparatus” of the present disclosure.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

The whole or part of the example embodiments disclosed above can be described as, but not limited to, the following supplementary notes. Some or all of the elements (for example, configurations and functions) described in each supplementary note dependent on Supplementary Note 1 can also be dependent on independent supplementary notes of other categories by the same dependency relationship. Some or all of the elements described in any Supplementary Note may be applied to various types of hardware, software, recording means for recording software, systems, and methods.

### (Supplementary Note 1)

An information processing apparatus including:
an acquisition unit that acquires input information regarding a review of training from an employee;
an extraction unit that extracts a learning content of the employee in the training based on the input information; and
an output unit that outputs coaching card information based on information extracted by the extraction unit.

### (Supplementary Note 2)

The information processing apparatus according to Supplementary Note 1, in which the extraction unit extracts information indicating a training name, a review date, a review outline, a learning content, details of the learning content, an action item, a progress status of the action item, and a next action plan based on a natural language processing result of the input information.

### (Supplementary Note 3)

The information processing apparatus according to Supplementary Note 2, in which the extraction unit generates a question for extracting the action item and the learning content based on the input information, and extracts the action item and the learning content based on an answer of the employee to the question.

### (Supplementary Note 4)

The information processing apparatus according to Supplementary Note 1 or 2, in which the extraction unit uses a model machine-learned using a combination of past input information and learning contents as training data.

### (Supplementary Note 5)

The information processing apparatus according to Supplementary Note 1 or 2, in which the extraction unit extracts a specific action item of the employee by natural language processing based on the input information, and transmits a meeting holding notification based on the specific action item to the employee and a manager of the employee.

### (Supplementary Note 6)

The information processing apparatus according to Supplementary Note 5, in which the holding notification includes the coaching card information.

### (Supplementary Note 7)

The information processing apparatus according to Supplementary Note 5, in which the output unit responds to a question from the manager by using a natural language processing technology by using the coaching card information.

### (Supplementary Note 8)

The information processing apparatus according to Supplementary Note 7, in which the output unit presents an example of a question that the manager should ask at the meeting with the employee by using the coaching card information.

### (Supplementary Note 9)

An information processing method including:
acquiring input information regarding a review of training from an employee;
extracting a learning content of the employee in the training based on the input information; and
outputting coaching card information based on the extracted information.

### (Supplementary Note 10)

A non-transitory computer-readable medium having stored therein a program for causing a computer to execute:
acquiring input information regarding a review of training from an employee;
extracting a learning content of the employee in the training based on the input information; and
outputting coaching card information based on the learning content.

What is claimed is:

1. An information processing apparatus comprising:
at least one memory storing instructions; and
at least one processor configured to execute the instructions to:
acquire input information regarding a review of training from an employee;
extract a learning content of the employee in the training based on the input information; and
output coaching card information based on the extracted information.

2. The information processing apparatus according to claim 1, wherein the processor is further configured to execute the instructions to extract information indicating a training name, a review date, a review outline, a learning content, details of the learning content, an action item, a progress status of the action item, and a next action plan based on a natural language processing result of the input information.

3. The information processing apparatus according to claim 2, wherein the processor is further configured to execute the instructions to generate a question for extracting the action item and the learning content based on the input information, and extract the action item and the learning content based on an answer of the employee to the question.

4. The information processing apparatus according to claim 1, wherein the processor is further configured to execute the instructions to use a model machine-learned using a combination of past input information and learning contents as training data.

5. The information processing apparatus according to claim 1, wherein the processor is further configured to execute the instructions to extract a specific action item of the employee by natural language processing based on the input information, and transmit a meeting holding notification based on the specific action item to the employee and a manager of the employee.

6. The information processing apparatus according to claim 5, wherein the holding notification includes the coaching card information.

7. The information processing apparatus according to claim 5, wherein the processor is further configured to execute the instructions to respond to a question from the manager by using a natural language processing technology by using the coaching card information.

8. The information processing apparatus according to claim 7, wherein the processor is further configured to execute the instructions to present an example of a question that the manager should ask at the meeting with the employee by using the coaching card information.

9. An information processing method comprising:
acquiring input information regarding a review of training from an employee;
extracting a learning content of the employee in the training based on the input information; and
outputting coaching card information based on the extracted information.

10. A non-transitory computer-readable medium having stored therein a program for causing a computer to execute:
acquiring input information regarding a review of training from an employee;
extracting a learning content of the employee in the training based on the input information; and
outputting coaching card information based on the learning content.
